(19) United States
(12) Patent Application Publication
(10) Pub. No.: US 2026/0342281 A1
(43) Pub. Date: Oct. 29, 2026

(54) UNIVERSAL CONTROL DEVICE

(71) Applicants: Mustapha Belhabib, Aubel (BE); Abdallah Hanouh, Lésigny (FR); Idir Allouane, Cesson (FR)

(72) Inventors: Mustapha Belhabib, Aubel (BE); Abdallah Hanouh, Lésigny (FR); Idir Allouane, Cesson (FR)

(21) Appl. No.: 19/604,240

(22) PCT Filed: Jan. 6, 2025
(86) PCT No.: PCT/EP2025/050189

§ 371 Date: Jul. 7, 2026

(30) Foreign Application Priority Data
Jan. 7, 2024 (FR) 2400126

(51) Int. Cl. H02S 40/42; H02S 40/36

(52) U.S. Cl. CPC H02S 40/425; H02S 40/36

(57) ABSTRACT

A universal control device comprising a housing and, within the housing, an electronic control board, in particular of the Raspberry Pi type or any other type, configured to control external devices according to at least three, in particular at least four, different communication protocols, the electronic control board being connected to connection ports configured to allow the transmission, to external devices connected to these connection ports, of signals according to the different communication protocols.

### FIELD OF THE INVENTION

The invention relates to a power generation installation intended to be installed on a ground, in particular on a parking lot.

### BACKGROUND

Solar energy is a renewable energy source without supply limitations. However, manufacturing and operating costs can impact the interest in using solar energy. Furthermore, the electrical grid often finds itself saturated in summer, hence the need to install sufficient storage capacity not only for self-produced energy but also to offer a possibility to balance the grid.

### SUMMARY

The present invention aims in particular to improve solar power generation installations, in terms of production and storage.

An object of the invention is thus a power generation installation configured to be installed in particular on a ground, and in particular comprising a central pillar configured to support at least one roof provided with at least one solar panel, the roof comprising in particular at least one air circulation channel extending at least partially under the solar panel to allow the air in the channel to be heated by the heat released by the solar panel.

According to one aspect of the invention, the roof is formed in two parts disposed on either side of the central pillar.

According to one aspect of the invention, the two parts of the roof are parallel. The two parts of the roof can be an extension of one another.

According to one aspect of the invention, the two roof parts each extend along a plane inclined relative to the pillar.

In other words, the roof is not perpendicular to the pillar.

According to one aspect of the invention, the two roof parts extend along a common plane inclined relative to the pillar.

According to one aspect of the invention, the common plane is inclined relative to the pillar by an angle comprised between 70° and 90°, in particular by an angle of approximately 85°.

In another exemplary embodiment of the invention, the two parts of the roof extend in respective planes that are intersecting. In particular, these two parts of the roof form, in profile, a Y with the central pillar.

According to one aspect of the invention, the two parts of the roof are spaced from each other by an opening.

According to one aspect of the invention, the top of the pillar extends through this opening.

According to one aspect of the invention, this opening between the two roof parts further allows wind to flow into this opening so as to break the forces that a strong wind could exert on the installation.

According to one aspect of the invention, the two parts of the roof have an identical surface area.

Alternatively, one of the roof parts may have a larger surface area than the other roof part, or a different shape.

According to one aspect of the invention, the roof has a rectangular perimeter.

According to one aspect of the invention, the two parts of the roof each have a rectangular perimeter.

According to one aspect of the invention, the roof comprises at least one casing configured to support the solar panel(s). The width of the casing as well as that of the solar panels are adjustable (for example by being modular) to adapt to the standard widths of parking spaces, which can vary from one region to another.

According to one aspect of the invention, each part of the roof comprises its own casing on which the solar panel(s) are mounted.

According to one aspect of the invention, the casing comprises supports, in particular metallic ones, on which the solar panels are placed. For example, the casing comprises supports, in particular metallic ones, on which the solar panels are placed on the upper part and a high-pressure laminate panel, or other bio-sourced material, on the lower part.

According to one aspect of the invention, these supports are formed by a peripheral flange of the casing.

According to one aspect of the invention, the supports can also be formed by transverse bars disposed at different locations of the casing.

According to one aspect of the invention, the transverse support bars are rectilinear and disposed in a parallel and equidistant manner relative to one another.

According to one aspect of the invention, the opening between the two roof parts is formed between two parallel rectilinear edges facing these roof parts, and the transverse bars are parallel to these edges.

According to one aspect of the invention, the solar panel(s) thus rest on the peripheral flange and on the transverse bars which are then located under the solar panels.

According to one aspect of the invention, each casing comprises at least one air inlet slot configured to allow air to flow inside the casing and to allow the air to be heated by the solar panel(s) closing the casing. A mesh screen that is sufficiently fine is disposed on the inlet slots to filter out any external object or body. External transverse bars supporting the casings are configured to protect the air intake slots against the infiltration of rainwater.

According to one aspect of the invention, the air inlet slot extends along an edge of the casing.

According to one aspect of the invention, each casing comprises at least two air inlet slots disposed along two opposite sides of the casing. For the end panels, an additional slot could be added. The slots may have the same dimensions or be different from each other.

According to one aspect of the invention, the casing comprises an air collection slot configured to allow the evacuation of air coming from the inlet slot(s) and having circulated in the casing while being heated by the solar panel(s).

According to one aspect of the invention, the air inlet slot has an elongated shape.

According to one aspect of the invention, the air collection slot has an elongated shape. Multiple slots, in particular of circular or oval shape, are also conceivable.

According to one aspect of the invention, at least one of the air inlets into the casing is formed by one or more air inlet slots which are aligned along one side of the casing. Other secondary inlet slots can be placed perpendicularly to the collection slots.

According to one aspect of the invention, the air inlet slots and the collection slot(s) are parallel to each other.

According to one aspect of the invention, the air inlet slots and the collection slot(s) are perpendicular to the transverse support bars for the solar panels.

According to one aspect of the invention, the collection slot(s) are located equidistant from the air inlet slots.

According to one aspect of the invention, the installation further comprises a longitudinal beam connecting to the central pillar and the longitudinal beam extends into the space between the two parts of the roof, in particular parallel to the two facing edges of the two roof parts.

According to one aspect of the invention, the installation further comprises a transverse beam connecting to the central pillar and supporting the two roof parts.

According to one aspect of the invention, the installation thus comprises the central pillar which supports the longitudinal beam and the transverse beam.

It is thus possible to form the installation with a total number of pillars/beams equal to three. This number can be four in the case of distinct transverse beams, dedicated to each roof part.

According to one aspect of the invention, the longitudinal beam and the transverse beam intersect at a right angle.

According to one aspect of the invention, the air evacuation slot in the roof casing is open to the transverse beam which is hollow.

According to one aspect of the invention, the beams are hollow as well as the central pillar, so that the air having circulated in the casing and which is heated by the solar panel(s) circulates through the air evacuation slot in the direction of the transverse beam.

According to one aspect of the invention, this transverse beam is hollow and thus forms, entirely or partially, an evacuation channel for the heated air. Each transverse beam can be equipped with a fan to evacuate the air toward a main conduit, in particular in the longitudinal beam.

According to one aspect of the invention, this evacuation channel in the transverse beam extends into the longitudinal beam.

According to one aspect of the invention, the longitudinal beam is configured to evacuate the air circulating therein toward an air heat recovery system.

According to one aspect of the invention, this system comprises for example a heat pump placed for example in a building to heat it.

According to one aspect of the invention, the installation comprises a fan, in particular an electric fan, configured to draw the air towards the air circulation channel in the longitudinal beam.

According to one aspect of the invention, this drawing of air makes it possible to create the air flow from the air inlet slot(s) on the roof casing towards the channel of the longitudinal beam.

According to one aspect of the invention, the fan is a rotary blade fan.

According to one aspect of the invention, the fan is placed within the longitudinal beam. Other fans can also be placed on each transverse beam.

According to one aspect of the invention, the pillar and/or the longitudinal beam and/or the transverse beam are each made with an assembly of plates in particular based on bio-sourced materials, wood or others such as high-pressure laminates of paper and resins intended for exterior cladding.

According to one aspect of the invention, this assembly of plates forms an external envelope of the pillar and/or of the longitudinal beam and/or of the transverse beam.

According to one aspect of the invention, the assembly further comprises beam elements, in particular made of wood, arranged parallel to each other on a contour, for example a rectangular contour, and between which the plates are arranged. The beam elements can also be made of steel, in particular for the central pillar where heat exchange is not critical.

For the central pillar, these beam elements measure for example 3 to 6 meters or more.

According to one aspect of the invention, within the interior space of this envelope, honeycomb structures, for example made of plastic material, are arranged. This makes it possible to reinforce the pillar and/or the beams and, at the same time, to allow air circulation.

According to one aspect of the invention, the honeycomb structure has a rectangular or square perimeter.

According to one aspect of the invention, the honeycomb structure has a grid or honeycomb shape.

According to one aspect of the invention, the honeycomb structure occupies an entire interior section of the pillar or of the beam.

According to one aspect of the invention, several honeycomb structures are provided in the hollow pillar and/or the hollow beam, in particular at a distance from one another.

According to one aspect of the invention, the honeycomb structures can be made of reinforced plastic material, in particular with glass fibers.

According to one aspect of the invention, the wooden plate assembly is reinforced by reinforcements, in particular metallic reinforcements.

According to one aspect of the invention, the metallic reinforcements are on an external face of the plate assembly. As a variant, the metallic reinforcements can be on the internal face, in particular for aesthetic or functional reasons when thermal conduction is not affected.

According to one aspect of the invention, the metallic reinforcements can represent a V or cross shape.

According to one aspect of the invention, the metallic reinforcements are configured to mechanically reinforce the pillar and/or the longitudinal beam and/or the transverse beam.

According to one aspect of the invention, the metallic reinforcements can also be used to interconnect the longitudinal beam and the transverse beam to the central pillar.

The invention is particularly advantageous because it allows a dual power generation, namely energy in electrical form thanks to the solar panels and energy in the form of heat recovered by the air circulation which recovers the heat released by the solar panels.

According to one aspect of the invention, the energy produced can be used for industrial, commercial or residential applications. The installation according to the invention can be placed for example on a parking lot, for example of a shopping center, a train station, an airport or an industrial complex.

According to one aspect of the invention, the installation comprises an electrical charging station or several electrical charging stations configured for charging one or more electric vehicles parked in the spaces covered by the installation.

According to one aspect of the invention, the charging station comprises a charging plug to be connected to an electric vehicle.

According to one aspect of the invention, an electrical circuit allows the solar panels to be connected to an inverter capable of producing electricity compatible with charging an electric vehicle.

According to one aspect of the invention, the inverter is arranged on the installation.

For example, the inverter is attached to the central pillar of this installation.

According to one aspect of the invention, the inverter can be placed at a height sufficient to be higher than the average height of a person.

According to one aspect of the invention, the inverter is placed for example at 2 m or more from the ground.

According to one aspect of the invention, the charging station is placed on a base of the installation.

According to one aspect of the invention, the charging station is placed against the pillar. Very fast charging stations, which are bulkier, could be placed longitudinally away from the pillar, at a distance equal to or less than the width of a parking space. Compact charging stations, especially when they are powered directly by the batteries with direct current without passing through the inverter, can be integrated into the central pillar.

According to one aspect of the invention, the roof is configured to cover 1 or 4 parking spaces for motor vehicles.

According to one aspect of the invention, each roof part is configured to receive a plurality of solar panels, for example 4 or 5 solar panels.

According to one aspect of the invention, the roof has a total length of at least 2 meters, measured parallel to the longitudinal beam.

According to one aspect of the invention, the roof has a dimension measured along the transverse beam of at least 4 meters, or 5 meters.

According to one aspect of the invention, each solar panel is configured to have a power density of at least 400 Wp (Watt-peak) per panel.

According to one aspect of the invention, this power density can be chosen at 700 Wp nominal.

According to one aspect of the invention, the roof is inclined and has a lower edge which is closest to the ground when the installation is mounted. This lower edge is at a height of about 4.2 meters from the ground. This makes it possible to meet safety standards.

According to one aspect of the invention, the central pillar is hollow and defines a housing for receiving one or more battery modules.

According to one aspect of the invention, each battery module is connected to the inverter, itself connected to the solar panels which are then used for the electrical charging of the battery module(s).

According to one aspect of the invention, the battery module can be based on sodium technology. As a variant, lithium battery technology is used.

According to one aspect of the invention, the honeycomb structures are configured to define the different housings receiving the battery modules.

According to one aspect of the invention, the central pillar comprises housings on several levels to receive the battery modules.

According to one aspect of the invention, the central pillar is fixed to an at least partially buried base.

According to one aspect of the invention, the base is configured to be buried in the ground and is of relatively low height, this height being in particular less than 600 mm.

According to one aspect of the invention, the installation comprises a buried anchoring system configured to keep the base of the central pillar anchored in the ground.

According to one aspect of the invention, the anchoring device comprises buried cables each having an end secured to the base of the installation and another end attached to a peg configured to be fixed deep in the ground.

According to one aspect of the invention, there are four cables. In particular, the anchoring cables also serve as an electrical ground conduit for the installation. The anchoring cables of one of the installations could be longer than the others by several meters in depth to serve as a lightning rod. These particular anchors are connected by wiring to a mast on the roof to channel lightning.

According to one aspect of the invention, the base of the installation protrudes over a certain height from the ground when the base is fixed to the ground.

According to one aspect of the invention, the base has, over this emerged height, a shape chosen to serve as a stop for a vehicle wheel.

Thus when a vehicle approaches the central pillar to park under the roof, the wheel of the car closest to the central pillar abuts against the base so as to signal to the driver that he cannot approach the central pillar any further.

This constitutes reliable safety to prevent a vehicle from striking the central pillar of the installation. If necessary, additional safety posts could be added.

According to one aspect of the invention, the base has a cross-shaped border configured to serve as a stop for a vehicle wheel.

According to one aspect of the invention, the installation uses durable materials such as wood and metal.

According to one aspect of the invention, the parts of the installation can furthermore be reused, repaired or recycled.

According to one aspect of the invention, wood is used in the beams and pillars and can be a wood treated using copper oil under high pressure in an autoclave.

According to one aspect of the invention, the wooden panels under the solar panels and which form the casing are protected by a metallic shield to avoid thermal stress on these wooden panels.

According to one aspect of the invention, the installation comprises a cleaning system for the solar panels.

According to one aspect of the invention, the cleaning system is of the hydraulic type.

According to one aspect of the invention, the cleaning system comprises a member for projecting liquid onto the solar panel(s).

According to one aspect of the invention, this liquid projecting member comprises a tube placed along an upper edge of the roof, or of each roof part.

According to one aspect of the invention, the tube is provided with a slot, in particular a longitudinal one, along this upper edge of the roof.

According to one aspect of the invention, a liquid is projected through this slot, in particular under moderate pressure, with a view to cleaning the surface of the solar panels, in particular without damaging them.

According to one aspect of the invention, the tube is connected to a water reserve, for example a rainwater recovery reserve.

According to one aspect of the invention, the connection between the reserve and the projection tube(s) is achieved by a conduit housed in the central pillar.

According to one aspect of the invention, the conduit, preferably rigid, is made of reinforced plastic material, for example reinforced with glass fibers. The conduit can also serve as a reinforcement for the central pillar by binding to the wooden beams through honeycomb composite plates.

According to one aspect of the invention, the conduit extends from the bottom to the top of the central pillar.

For example, the conduit has a height of at least 80% or 90% of the total height of the central pillar. Advantageously, the volume of water in the conduit does not exceed 90% in order to contain the volume of frozen water. The choice of composite materials for the conduit or reservoir must allow it to withstand freezing constraints while participating in the rigidity of the main pillar structure.

According to one aspect of the invention, one or more pipes can be provided to connect the water projection tube to this vertical conduit.

According to one aspect of the invention, the pipe(s) are arranged in the casing which supports the solar panel(s).

According to one aspect of the invention, the cleaning system can comprise two water projection tubes, one for one of the parts of the roof and the other for the other part of the roof.

According to one aspect of the invention, the installation comprises a water pump configured to pump water from the reserve and direct it to the cleaning system.

According to one aspect of the invention, the installation comprises a gutter configured to recover rainwater flowing on the roof, and to direct the recovered rainwater into the reserve of the central pillar.

According to one aspect of the invention, the pump for pumping water is of the electric type. It can be activated by a dust sensor and/or at predefined time intervals.

According to one aspect of the invention, the recovered water can be filtered before joining the reservoir. Advantageously, the water level in the reservoir is controlled by a distance sensor located on a main control box installed at the top of the central pillar.

According to one aspect of the invention, the installation comprises one or more thermal control cameras, in particular fixed to the top of the central pillar, and configured to measure the temperature on the surface of the solar panels.

According to one aspect of the invention, this thermal camera is fixedly mounted on the central pillar or movably mounted, for example to allow it to turn and be oriented toward the solar panels. In particular, the thermal cameras are fixedly mounted on the central pillar or the camera is movably mounted in particular when it involves a single camera.

According to one aspect of the invention, the thermal camera allows for the continuous monitoring of the potential appearance of hot spots on the surface of the solar panels.

Hot spots can represent a danger to the installation. The thermal camera optionally allows for detecting the presence of animals (birds, rodents, insects) which can damage the installation through the deposit of waste, nests or by gnawing cables. The detection will be transmitted to an electronic module which triggers, for example, an animal-repelling sound. It can also contribute to alerting of human malicious action (theft, breakage). Temperature sensors are optionally used to monitor the temperature in locations requiring it.

According to one aspect of the invention, the installation comprises a control unit configured to receive information coming from the thermal camera and to trigger an alert when a hot spot has been detected on one of the solar panels.

According to one aspect of the invention, the roof comprises a fire alert system configured to generate an alert in the event of fire or abnormal temperature on the roof.

According to one aspect of the invention, the fire alert system comprises wires that snake under the solar panels.

According to one aspect of the invention, these wires are configured to melt in the event of high temperature.

The melting of the wire creates a short circuit, which triggers an alert. The wires could also be connected to the control box to ensure pre-alerts (for example by messaging, telephone, ...).

According to one aspect of the invention, the wires of the fire alert system are placed in the path of the air flow under the solar panels so that its wires generate turbulence in this air flow promoting a better heat exchange between the air and the solar panels. The wires are in particular retained by devices on the lower part of the casings in order to remain at a controlled and sufficient distance from the solar panels.

It is possible to provide perturbation elements other than these wires or in addition to these wires.

The invention also relates to an assembly of installations comprising a plurality of installations as described above, these installations being in particular arranged side by side.

For example, the longitudinal beams are placed in the extension of one another.

Thus it is possible to recover heated air at the end of this succession of longitudinal beams.

It is thus possible to create a large surface of solar panels sheltering several parking spaces.

The recovery of calories thanks to the invention can, for example, be used to heat buildings thanks to the air circulating under the solar panels.

The air which serves to transport calories coming from the solar panels could be replaced by any other appropriate fluid, for example a liquid.

The invention provides a modular solution in terms of mounting the installations, each installation being able to be autonomous.

The invention makes it possible in particular to arrange identical installations side by side with a chosen number to cover predetermined needs. This makes it possible in particular not to resort to a centralized system sensitive to each partial default of the installation.

According to one aspect of the invention, each installation is energy autonomous for its operation.

According to one aspect of the invention, each installation is autonomous in terms of electronic control.

According to one aspect of the invention, each installation is mechanically autonomous.

The recovered rainwater can be used to wash cars, to cool charging stations, batteries, the inverter or to supply the sanitary facilities of surrounding buildings.

The installation can comprise luminous information or alert devices which are electrically powered by the battery modules.

The installation can comprise a control unit such as a computer, capable of collecting information coming from the different sensors and equipment of the installation.

Information transmissions can be carried out wirelessly using an encryption protocol towards a central antenna.

The installation can comprise a screen configured to display information, for example on air quality or the weather.

The installation is particularly ergonomic.

The invention makes it possible to charge several vehicles at once, whether these vehicles are parked facing forward or backward.

The installation can be equipped with one or more display screens, for example for information or advertising, in particular in the case of shopping center parking lots.

The installation can be equipped with ultrasonic vehicle presence detectors in order to identify available parking spaces.

Parking spaces could be reserved by applications in vehicles or mobile phones.

According to one aspect of the invention, the installation is equipped with a temperature regulation device to prevent the water in the reservoir from freezing in winter and to allow an optimal functioning of the necessary batteries, in particular for lithium iron phosphate technology. The heating is achieved by a self-regulating cable or a simple electrical resistor surrounding the reservoir. The cooling of the water in the reservoir and therefore of the batteries surrounding it is achieved by the circulation of water over the solar panels during the night.

The invention further relates, independently or in combination with the foregoing, to a universal control device comprising a housing and, within the housing, an electronic control board, in particular of the Raspberry Pi type or any other type, configured to control external devices according to at least three, in particular at least four, different communication protocols, the electronic control board being connected to connection ports configured to allow the transmission, to external devices connected to these connection ports, of signals according to the different communication protocols.

According to one aspect of the invention, the electronic control board is unique. Thus the universal control device is of the single-board type.

As a variant, the universal control device comprises several electronic control boards.

According to one aspect of the invention, the universal control device comprises an internal electrical power source such as a battery.

As a variant, the universal control device is devoid of an internal electrical power source, and the housing comprises an electrical power connector making it possible to plug an electrical power cable into the universal control device.

The present invention allows extensive integration of different control functions using control protocols which can be different.

According to one aspect of the invention, the universal control device according to the invention is configured to be usable in various fields, thanks to the implementation in the universal control device of several communication protocols.

The universal control device is notably configured to be connected to one or more energy management devices, notably for solar energy.

The invention allows, thanks to a universal control device presented in a single housing, to easily control different functions of an installation, for example of the solar type.

These different functions are for example chosen from:
the transmission of data representative of a battery charge level;
the control of a fan to cool a solar panel;
the control of a solar panel cleaning system, of the hydraulic type;
the control of a water circuit, notably recovered rainwater, to cool the charging stations, or the batteries, or the inverter.

According to one aspect of the invention, the universal control device is configured to be connected to at least one sensor, for example a temperature sensor.

According to one aspect of the invention, the sensor is for example configured to measure the temperature of a battery or a solar panel or heated water.

According to one aspect of the invention, the universal control device is configured to be connected to a plurality of sensors.

The invention is particularly advantageous because, with a universal control device provided with different communication ports usable according to different protocols, it is possible to meet varied needs. The invention thus allows great modularity to the extent that the same universal control device can be used in different applications by implementing communication protocols that can differ from one application to another.

The universal control device thus plays the role of a universal platform which is more advantageous than a conventional computer which cannot process a multitude of protocols, unless additional boards are connected to it.

The present invention offers a solution that is much more compact, simple, secure and practical than a classic laptop computer.

The universal control device is configured to operate with at least one of the protocols, or several of the following protocols:
CAN protocol (Controller Area Network);
Modbus protocol notably for RS485 communication control;
I2C protocol (Inter-Integrated Circuit) notably for camera control for example where the clock indicator is necessary;
control protocol for an electronic relay, for example to control an electric motor;
control protocol for Mosfet transistors notably for systems requiring an ultra-fast reaction;
control protocol by PWM (Pulse Width Modulation) signals notably to control the electrical power transmitted to an electronic device;
Wi-Fi;
4G/5G network.

According to one aspect of the invention, the universal control device is configured to be able to be connected to at least one of the following external devices:
an electrical inverter, for example associated with a battery;
a battery, notably to manage electrical storage in a battery;
an electrical charging device, notably for an electric vehicle, notably to manage the electrical charging of an electric car;
one or more cameras, notably one or more thermal cameras;
an electric motor, notably belonging to a water pump;
an electric fan;
one or more sensors, notably one or more temperature sensors;
one or more ultrasonic sensors;
one or more self-regulating cables (these are special heating cables designed to maintain a constant temperature in varied applications);
one or more fire detection cables;
a lighting device;
a display device, for example an LCD or TFT type screen;
a keyboard;
a WiFi module;
a 4G or 5G module.

According to one aspect of the invention, the universal control device is configured to be connected to external devices belonging to an energy production installation, notably with solar panel(s).

This energy production installation can be an installation integrated into a parking lot, or an agricultural farm or a house.

According to one aspect of the invention, the housing can be made mainly of plastic material, notably molded plastic material.

According to one aspect of the invention, the housing is closed, notably in a watertight manner.

According to one aspect of the invention, the housing has a shape inscribed in a geometric block.

According to one aspect of the invention, the connection ports are arranged in one or more rows.

In each row, the connection ports, for example numbering 4, 5 or 6, are aligned.

According to one aspect of the invention, the universal control device comprises four rows of connection ports along four sides of one face of the housing.

According to one aspect of the invention, the face of the housing comprises a low wall, notably with a square or rectangular perimeter, and the rows of connection ports are arranged around this low wall.

According to one aspect of the invention, the connection ports are on a single face of the housing, notably the lower face.

According to one aspect of the invention, the rows of connection ports are made on a bottom cover of the housing.

According to one aspect of the invention, the universal control device is configured to be housed, preferably removably, in a compartment of the installation. The universal control device is configured to be replaceable by simple disassembly.

According to one aspect of the invention, the universal control device is configured to allow thermal management of an energy production installation.

According to one aspect of the invention, the universal control device is configured to allow operating with a Linux system and/or to allow an Internet connection and/or to allow a WiFi connection and/or to allow a 4G/5G network connection and/or to allow coding in Python language and/or to allow being connected to artificial intelligence tools.

According to one aspect of the invention, the connection ports are chosen from: an HDMI connection port, and/or an Ethernet connection port, and/or a USB connection port.

According to one aspect of the invention, the universal control device is configured to operate with a 12-volt power supply.

According to one aspect of the invention, the universal control device is configured to operate at an electrical power of 100 watts, 200 watts or 300 watts.

According to one aspect of the invention, the universal control device is configured to supply heat, notably via one or more cables, to prevent a conduit and/or a battery from freezing.

The invention makes it possible to have a single housing, instead of several housings.

According to one aspect of the invention, the electronic components placed in the housing are components of a computer server, notably a Central Processing Unit (CPU), or a Graphics Processing Unit (GPU). These components, which are notably microprocessors, are notably configured to run artificial intelligence. The universal control device according to the invention can be configured as an artificial intelligence server.

According to one aspect of the invention, the universal control device comprises at least one cooling system configured to cool electronic components inside the housing.

According to one aspect of the invention, the cooling system comprises an electric fan, notably triggerable in connection with a temperature sensor configured to measure the temperature in the housing.

According to one aspect of the invention, the cooling system is placed in the housing.

As a variant, cooling can be done by water (using a water circuit), instead of by air (fan).

According to one aspect of the invention, the universal control device is configured to perform edge computing data processing operations.

For this, the universal control device comprises notably:
a data collection module configured to interact with one or more connected devices or one or more local sensors,
optionally a local processing module configured to analyze and process the collected data directly on the device,
a communication module configured to transmit processed data or analysis results to a central server or an external system, if necessary.

The invention also relates to an assembly comprising a universal control device as described above, and devices connected to the universal control device to be controlled by this universal control device.

The invention also relates to an energy production installation configured to be installed notably on a ground, notably on a parking lot, and comprising a central pillar configured to carry at least one roof provided with at least one solar panel, the installation comprising a compartment for housing a universal control device as described above, which is configured to control devices of the installation.

The invention also relates to a control method using a universal control device as described above, to control devices connected to the universal control device.

According to one aspect of the invention, the universal control device can be used for controlling an electric vehicle.

According to one aspect of the invention, the universal control device can be used as a communication/telephony means.

According to one aspect of the invention, the universal control device could serve as a means of accessing the Internet network.

### BRIEF DESCRIPTION OF THE DRAWINGS

Other characteristics, details and advantages of the invention will emerge more clearly upon reading the following description on the one hand, and several examples of embodiments given as a purely non-limiting indication with reference to the appended schematic drawings on the other hand, in which:

FIG. 1 is a perspective representation of a parking assembly comprising several installations according to an embodiment of the invention;

FIG. 2 is a view from a different direction of the parking assembly of [FIG. 1];

FIG. 3 is a perspective representation of an installation of the parking assembly of FIG. 1;

FIG. 4 is a representation of the central pillar of the parking assembly of [FIG. 1];

FIG. 5 is a representation of a casing of the installation of [FIG. 3];

FIG. 6 is a representation of the casing of [FIG. 6], viewed from below;

FIG. 7 is a cross-sectional representation of the installation of [FIG. 3];

FIG. 8 is a representation of the cleaning system of the installation of [FIG. 3];

FIG. 9 is a representation of the interior of the central pillar of the installation of FIG. 3;

FIG. 10 is a representation of the interior of the longitudinal beam of the installation of [FIG. 3];

FIG. 11 is a representation of a charging station of the installation of [FIG. 3];

FIG. 12 is a representation of a heating cable for the water of the installation of [FIG. 3];

FIG. 13 is a representation of an installation with a Y-shaped roof part arrangement;

FIG. 14 is a representation of a casing with variable section collection slots;

FIG. 15 is a representation of a universal control device according to an embodiment of the invention;

FIG. 16 is a representation of the universal control device of [FIG. 15], from another view;

FIG. 17 is a cross-sectional representation of the universal control device of [FIG. 15].

### DETAILED DESCRIPTION

The characteristics, variants and different embodiments of the invention can be associated with one another, according to various combinations, insofar as they are not incompatible or exclusive of one another. One can notably imagine variants of the invention comprising only a selection of characteristics described subsequently in isolation from the other characteristics described, if this selection of characteristics is sufficient to confer a technical advantage and/or to differentiate the invention from the prior state of the art.

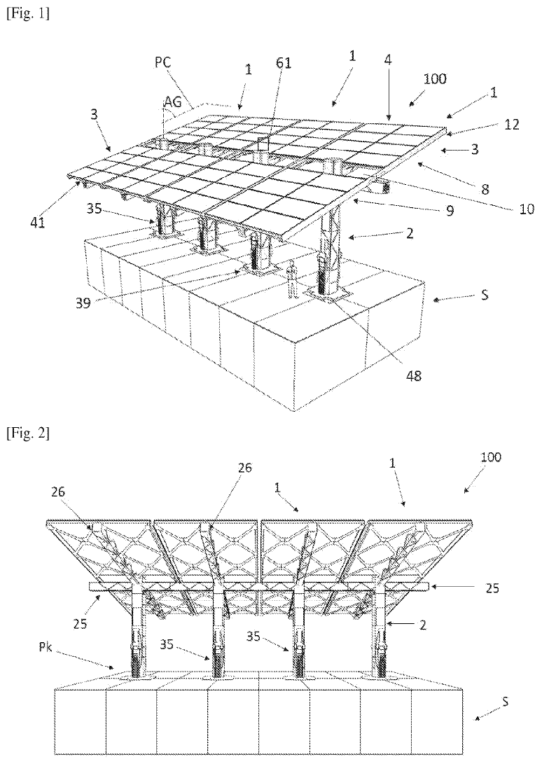

There is represented, in FIGS. 1 and 2, an assembly 100 comprising a plurality of energy production installations 1 according to an embodiment of the invention, these installations 1 being arranged side by side.

The installations 1 are placed on a parking lot, for example of a shopping center, a train station, an airport or an industrial complex.

Each energy production installation 1 is configured to be installed on a ground S, and comprises a central pillar 2 configured to support a roof 3 provided with solar panels 4.

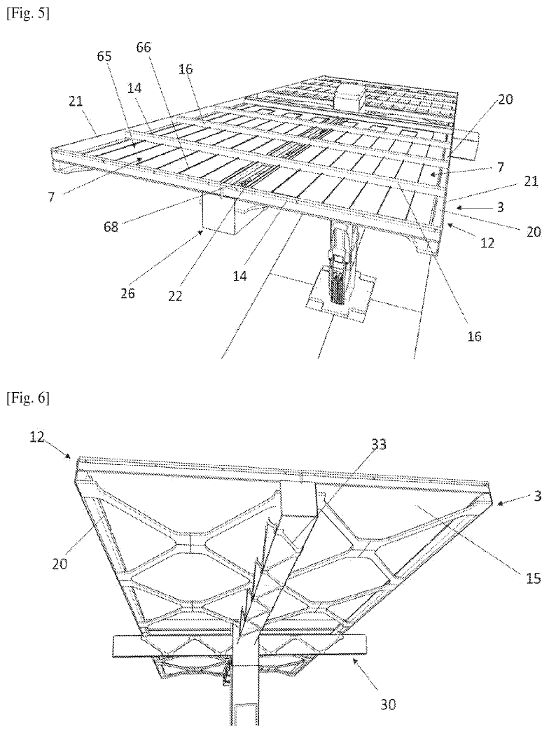

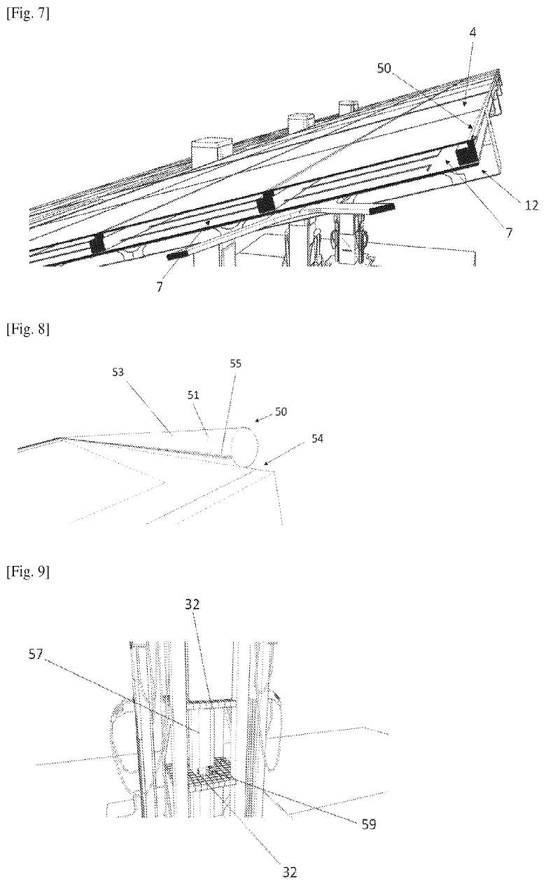

The roof 3 comprises air circulation channels 7 extending under the solar panels 4 to allow the air in each channel 7 to be heated by the heat released by the solar panels 4, as illustrated in [FIG. 5] and 7.

Each roof 3 is made in two parts 8 and 9 arranged on either side of the central pillar 2.

The two parts 8 and 9 of the roof 3 are parallel and are an extension of each other.

The two parts 8 and 9 of the roof extend along a common plane PC inclined with respect to the pillar 2.

The common plane PC is inclined with respect to the pillar 2 by an angle AG between 70° and 90°, notably an angle of approximately 85°.

The two parts 8 and 9 of the roof are spaced apart from each other by an opening 10.

The top of the pillar 2 extends through this opening 10.

This opening 10 between the two roof parts also allows the wind to flow into this opening 10 so as to break the forces that a strong wind could exert on the installation.

The two parts 8 and 9 of the roof 3 have an identical area and have a rectangular perimeter.

Each roof 3 comprises at least one casing 12 configured to support the solar panels 4. The width of the casing 12 as well as that of the solar panels 4 are adjustable (for example by being modular) to adapt to the standard widths of parking spaces, which can vary from one region to another.

Each part 8, 9 of the roof comprises its own casing 12 on which the solar panels 4 are mounted.

The casing 12 comprises metallic supports 14 on which the solar panels are placed.

For example, the casing 12 comprises supports notably metallic 14 on which the solar panels are placed on the upper part and a high pressure laminate panel 15, or other biosourced material, on the lower part, as illustrated in [FIG. 6].

These supports 14 are notably formed by a peripheral rim of the casing 12.

The supports 14 can also be formed by transverse bars 16 arranged at different locations of the casing 12.

The transverse support bars 16 are straight and arranged parallel and equidistant to each other.

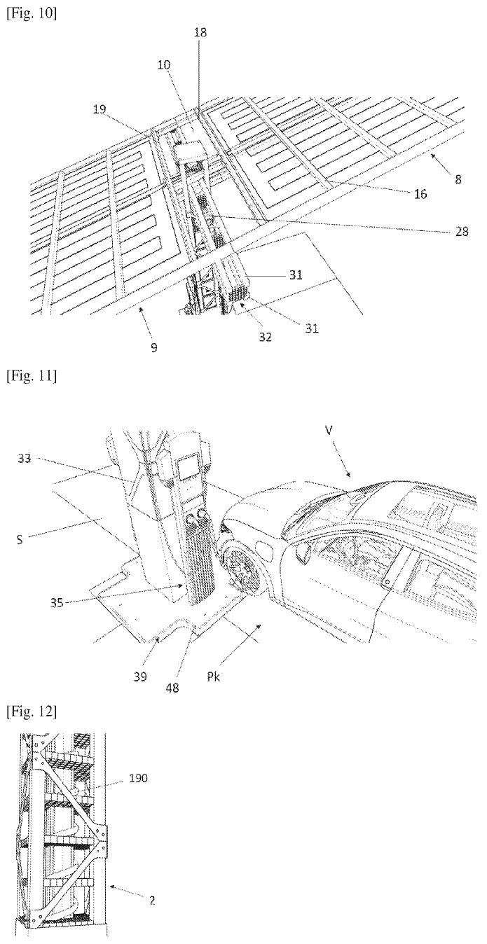

The opening 10 between the two roof parts 8, 9 is formed between two parallel straight edges 18, 19 facing these roof parts 9, 9, and the transverse bars 16 are parallel to these edges, as illustrated in FIG. 10.

The solar panels 4 thus rest on the peripheral rim and on the transverse bars 16 which are then located under the solar panels.

Each casing 12 comprises air inlet slots 20 configured to allow air to flow inside the casing 12 and to allow the air to be heated by the solar panels 4 which close the casing 12. A sufficiently fine mesh grid can be placed over the inlet slots 20 to filter out any external object or body. External crossbars supporting the casings 12 are configured to protect the air intake slots against the infiltration of rainwater.

Each air inlet slot 20 extends along an edge 21 of the casing 12.

Each casing 12 comprises pairs of air inlet slots 20 arranged along two opposite sides 21 of the casing 12. For the end panels, an additional slot could be added. The slots can be of the same dimensions or different from each other.

The casing 12 comprises an air collection slot 22 configured to allow the evacuation of the air coming from the inlet slots 20 and having circulated in the casing 12 while being heated by the solar panels 4, as illustrated in [FIG. 5].

The air inlet slot 20 has an elongated shape.

The air collection slot 22 has an elongated shape.

The air inlet slots 20 are aligned along each side 21 of the casing 12. Other secondary inlet slots can be placed perpendicular to the collection slots.

The air inlet slots 20 and the collection slots 22 are parallel to each other, and are perpendicular to the transverse support bars 16 for the solar panels.

The collection slots 22 are located equidistant from the air inlet slots 20.

The installation 1 further comprises a longitudinal beam 25 connecting to the vertical central pillar 2 and the longitudinal beam 25 extends into the space/opening 10 between the two parts 8, 9 of the roof, parallel to the two edges 21 of the roof.

In the assembly 100 of several installations 1, the longitudinal beams 25 are placed in the extension of each other.

Thus it is possible to recover heated air at the end of this succession of longitudinal beams 25.

The installation 1 further comprises a transverse beam 26 connecting to the central pillar 2 and carrying the two roof parts 8, 9.

The installation 1 thus comprises the central pillar 2 which carries the longitudinal beam 25 and the transverse beam 26.

It is thus possible to form the installation 1 with a total number of pillars/beams equal to three.

The longitudinal beam 25 and the transverse beam 26 intersect at right angles.

The air evacuation/collection slot 22 in the roof casing 12 is open to the transverse beam 26 which is hollow.

The beams 25 and 26 are hollow as is the central pillar 2, so that the air having circulated in the casing 12 and which is heated by the solar panels 4 circulates through the air evacuation slot 22 in the direction of the transverse beam 26.

Each transverse beam 26 is hollow and thus forms, in whole or in part, a heated air evacuation channel. Each transverse beam 26 can be equipped with a fan 28 (see [FIG. 10]) to evacuate the air to a main duct, in the longitudinal beam 25.

This exhaust channel in the transverse beam 26 extends into the longitudinal beam 25.

The longitudinal beam 25 is configured to exhaust the air circulating therein to an air heat recovery system. According to one aspect of the invention, this system comprises for example a heat pump placed for example in a building to heat it.

The fan 28 is electric, and configured to draw the air into the air circulation channel in the longitudinal beam 25.

This drawing in of air allows the creation of air flow from the air inlet slots 20 on the roof casing 12 to the channel of the longitudinal beam 25.

The fan 28 is placed within the longitudinal beam 25. Other fans can also be placed on each transverse beam 26.

The pillar 2 and/or the longitudinal beam 25 and/or the transverse beam 26 are each made with an assembly of plates based on biosourced materials, wood or others such as high pressure laminates of paper and resins intended for exterior cladding.

The assembly of plates 30 forms an outer casing of the pillar 2 and/or the longitudinal beam 25 and/or the transverse beam 26.

As can be seen in [FIG. 10], the assembly 30 further comprises wooden beam elements 31, arranged in a parallel manner, at the four corners of the rectangular perimeter, and between which the plates are arranged. The beam elements 31 can also be made of steel, particularly for the central pillar 2 where heat exchange is not critical.

For the central pillar 2, these beam elements 31 measure for example 3 to 6 meters or more.

In the inner space of this casing, honeycomb structures 32, made of plastic, are arranged.

Each honeycomb structure 32 has a rectangular or square outline, and has a grid or honeycomb shape.

The honeycomb structure 32 occupies an entire inner section of the pillar 2 or the beam 25, 26.

Several honeycomb structures 32 are provided in the hollow pillar 2 and/or the hollow beam 25, 26, at a distance from each other.

The honeycomb structures 32 can be made of reinforced plastic, particularly with glass fibers.

The assembly of wooden plates 30 is reinforced by reinforcements 33, notably metal reinforcements 33.

The reinforcements 33 are on an outer face of the assembly of plates 30. Alternatively, the reinforcements 33 can be on the inner face, in particular for aesthetic or functional reasons when heat conduction is not affected.

The metal reinforcements 33 can represent a V-shape or a cross shape, and are configured to mechanically reinforce the pillar 2 and/or the longitudinal beam 25 and/or the transverse beam 26.

The metal reinforcements 33 can also be used to interconnect the longitudinal beam 25 and the transverse beam 26 to the central pillar 2.

The installation 1 comprises an electric charging station 35 or several electric charging stations 35 configured to charge one or more electric vehicles V parked in the spaces Pk covered by the installation 1, as illustrated in [FIG. 11].

The charging station 35 comprises a charging socket to be plugged into an electric vehicle V.

An electric circuit allows the solar panels 4 to be connected to an inverter 37 capable of producing electricity compatible with an electric vehicle charge.

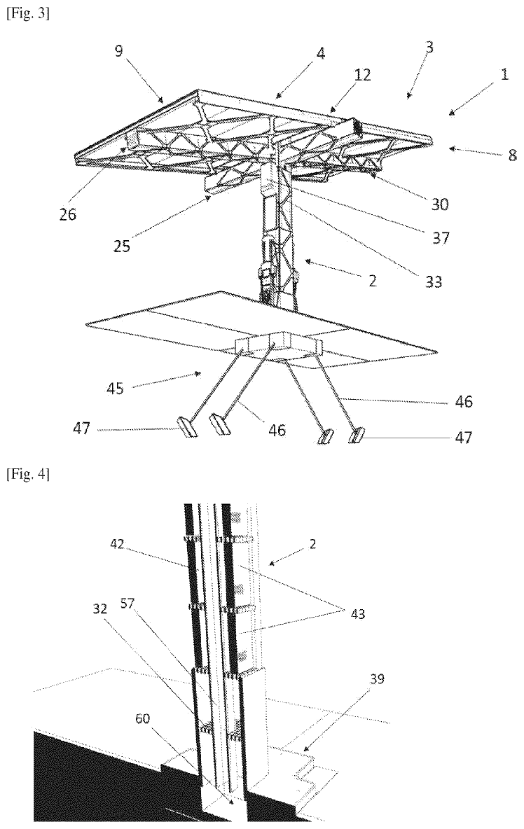

The inverter 37 is arranged on the installation 1, being attached to the central pillar 2 of this installation (see [FIG. 3]).

The inverter 37 can be placed at a height sufficient to be higher than the average height of a person.

The inverter 37 is placed for example at 2 meters or more from the ground.

The charging station 35 is placed on a base 39 of the installation 1, against the pillar 2.

The roof 3 is configured to cover one or four parking spaces Pk for motor vehicles.

Each part 8, 9 of the roof is configured to receive a plurality of solar panels, for example 4 or 5 solar panels.

The roof 3 has a total length of at least 2 meters, measured parallel to the longitudinal beam 25.

Each roof 3 has a dimension measured along the transverse beam 26 of at least 4 meters, or 5 meters.

Each solar panel 4 is configured to have a power density of at least 400 Wp (Watt-peak) per panel, chosen at 700 Wp nominal for example.

The roof 3 is inclined and has a lower edge 41 which is closest to the ground when the installation 1 is assembled. This lower edge 41 is at a height of about 4.2 meters from the ground.

The central pillar 2 is hollow and defines a housing 42 for receiving several battery modules 43.

Each battery module 43 is connected to the inverter 37, itself connected to the solar panels 4 which then serve to electrically charge the battery module 43.

The battery module 43 can be based on sodium technology.

The honeycomb structures 32 are configured to define the different housings 42 receiving the battery modules 43.

The central pillar 2 comprises housings 42 on several floors to receive the battery modules 43, as can be seen in FIG. 4.

The central pillar 2 is attached to the base 39.

The base 39 is configured to be buried in the ground and is of relatively low height, this height being notably less than 600 mm.

The installation 1 comprises a buried anchoring system 45 configured to keep the base 39 of the central pillar 2 anchored in the ground, as illustrated in [FIG. 3].

The anchoring device 45 comprises buried cables 46 each with an end secured to the base 39 of the installation and another end attached to an anchor peg 47 configured to be fixed deep in the ground.

The cables 46 are four in number. In particular, the anchoring cables also serve as an electrical ground conduit for the installation. The anchor cables 46 of one of the installations could be longer than the others by several meters deep to serve as a lightning rod. These particular anchors are connected by cabling to a mast on the roof 3 to channel lightning.

The base 39 of the installation protrudes a certain height above the ground when the base 39 is fixed to the ground.

The base 39 has, over this emerged height, a shape chosen to act as a stop for a vehicle wheel.

Thus when a vehicle approaches the central pillar 2 to park under the roof 3, the wheel of the car closest to the central pillar 2 abuts against the base 39 so as to signal to the driver that he cannot approach the central pillar 2 any further.

This constitutes a reliable safety measure to prevent a vehicle from colliding with the central pillar 2 of the installation.

The base 39 has a cross-shaped border 48 configured to serve as a stop for a vehicle wheel.

The installation 1 uses durable materials such as wood and/or metal.

According to one aspect of the invention, the wooden panels under the solar panels and which form the casing 12 are protected by a metal shield to prevent thermal stress on these wooden panels.

The installation 1 comprises a cleaning system 50 for the solar panels, of the hydraulic type, as illustrated in FIG. 8.

The cleaning system 50 comprises a member 51 for spraying liquid onto the solar panels 4.

This liquid spraying member 51 comprises a tube 53 placed along an upper edge 54 of the roof 3.

The tube 53 is provided with a longitudinal slot 55 along this upper edge 54 of the roof 3.

A liquid is sprayed through this slot 55, under moderate pressure, in order to clean the surface of the solar panels 4, without damaging them.

The tube 53 is connected to a water reserve 60, here a rainwater recovery reserve.

The connection between the reserve 60 and the spray tubes 53 is provided by a conduit 57 housed in the central pillar 2, visible in FIGS. 4 and 9.

The conduit 57, rigid, is made of reinforced plastic material, for example reinforced with fiberglass. The conduit 57 can also serve as reinforcement for the central pillar 2 by binding to the wooden beams through honeycomb composite plates.

The conduit 57 extends from the bottom to the top of the central pillar 2.

For example, the conduit 57 has a height of at least 80% or 90% of the total height of the central pillar 2. Advantageously, the volume of water in the conduit does not exceed 90% in order to contain the volume of frozen water. The choice of composite materials for the conduit or tank must allow it to withstand freezing stresses while contributing to the rigidity of the structure of the main pillar.

Several pipes can be provided to connect the water spray tube 53 to this vertical conduit 57.

These pipes are placed in the casings 12.

The cleaning system 50 can comprise two water spray tubes, one for one of the parts 8 of the roof 3 and the other for the other part 9 of the roof 3.

The installation 1 comprises a water pump 59 configured to pump water from the reserve 60 and direct it to the cleaning system 50.

The installation 1 comprises a gutter 68 configured to collect rainwater that flows on the roof 3, and to direct the collected rainwater into the reserve of the central leg.

The pump 59 for pumping water is of the electric type. It can be activated by a dust sensor and/or at predefined time intervals, or during the night in summer to cool the water of the tank heated by the heat released by the batteries.

The collected water can be filtered before reaching the tank 60. Advantageously, the water level in the tank 60 is monitored by a distance sensor located on a main control box installed at the top of the central pillar.

The installation 1 comprises one or more thermal monitoring cameras 61, notably attached to the top of the central pillar 2, and configured to measure the temperature on the surface of the solar panels 4.

This thermal camera 61 is fixedly mounted on the central pillar 2 or movably mounted, for example to allow it to turn and be oriented toward the solar panels 4. In particular, the thermal cameras are fixedly mounted on the central pillar 2 or the camera is movably mounted, notably when there is a single camera.

The thermal camera 61 makes it possible to constantly monitor the potential appearance of hot spots on the surface of the solar panels.

Hot spots can represent a danger to the installation 1. The thermal camera 61 optionally makes it possible to detect the presence of animals (birds, rodents, insects) that can damage the installation through the deposit of waste, nests or by chewing on the cables. The detection will be transmitted to an electronic module which triggers for example an animal repelling sound. It can also help alert to malicious human action (theft, breakage). Temperature sensors are optionally used to monitor the temperature in places that require it.

The installation can comprise a control unit configured to receive information from the thermal camera 61 and trigger an alert when a hot spot has been detected on one of the solar panels.

The roof 3 comprises a fire alert system 65 configured to generate an alert in the event of fire or an abnormal temperature on the roof 3.

The fire alert system 65 comprises wires 66 that meander under the solar panels 4.

These wires 66 are configured to melt in the event of a high temperature.

The melting of the wire creates a short circuit, which triggers an alert. The wires could also be connected to the control box to provide pre-alerts (for example by text message, telephone, ...).

The wires 66 of the fire alert system are placed in the path of the air flow under the solar panels so that its wires generate turbulence in this air flow promoting a better heat exchange between the air and the solar panels. The wires 66 are notably held by devices on the lower part of the casings to remain at a controlled and sufficient distance from the solar panels.

It is possible to provide disturbance elements other than these wires 66 or in addition to these wires.

When the ambient temperature is low or negative (less than 5 °C for example), the water in the tank 60 can be heated electrically by a cable 190 illustrated in [FIG. 12], or a heating strip or by other means to prevent the water from freezing while radiating heat to heat the batteries and thus increase their performance and extend their lifespan. In summer, the water in the tank 60 heated during the day by the batteries is cooled at night by flowing over the solar panels while simultaneously cleaning them, bearing in mind that the dust level is generally higher in summer. The cable 190 forms a spiral around the conduit 57 housed in the central pillar 2.

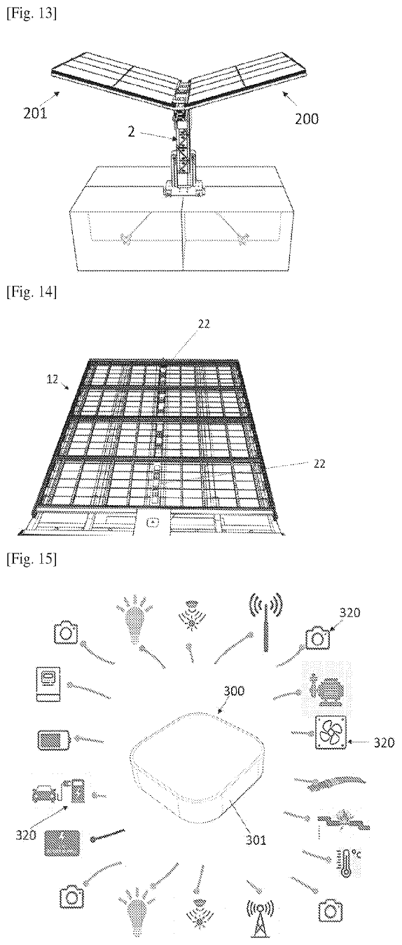

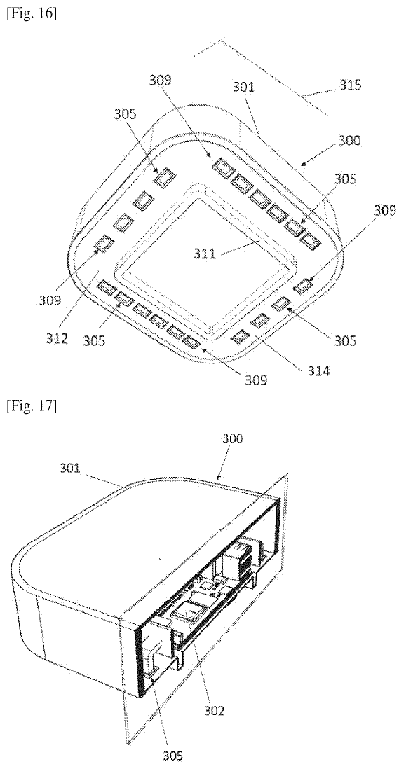

In another exemplary embodiment of the invention illustrated in [FIG. 13], the two roof parts 200 and 201 extend in respective intersecting planes, forming, in profile, a Y with the central pillar 2. Generally speaking, the arrangement of the roof parts can be adapted depending on environmental constraints and/or the need for water collection.

Fast charging stations whose power exceeds 100 kW could be placed far from the mast or central pillar 2.

In one example, the installation containing lithium or sodium batteries whose capacity could range from 5 kWh to more than 100 kWh allows the storage of electricity produced by the solar panels or to serve as a means to absorb excess electricity in the event of grid saturation during an excess of wind and photovoltaic production. This electricity could be fed back into the grid when demand requires it.

In a variant illustrated in FIG. 14, the cross-sections of the slots 22 can vary for better air uniformity in the casing 12. In particular, the further away one is from the pillar, the wider the collection slot 22 is to compensate for pressure drops.

Represented in FIG. 15 is a universal control device 300 comprising a housing 301 and, in the housing 301, an electronic control board 302, here of the Raspberry Pi type (other types of boards can be used), configured to control external devices according to a plurality of different communication protocols.

The electronic control board 302 is connected to connection ports 305 configured to allow the transmission, to external devices 320 connected to these connection ports 305, of signals according to the different communication protocols.

The electronic control board 302 is singular. Thus the universal control device is of the single-board type.

Alternatively, the universal control device 300 comprises several electronic control boards.

The universal control device 300 comprises an internal power source such as a battery.

Alternatively, the universal control device 300 has no internal power source, and the housing 301 comprises a power supply connector making it possible to connect a power supply cable to the universal control device via, for example, one of the ports 305.

The universal control device 300 according to the invention is used to control the various equipment of the installation 1 described above.

The universal control device 300 according to the invention is used to control the following functions:
the transmission of data representative of a charge level of a battery or battery module 43 (which defines one of the external devices) of the installation 1 described above;
the control of a fan 28 (which defines one of the external devices) to cool a solar panel 4 of the installation 1 described above;
the control of a cleaning system 50 (which defines one of the external devices) for the solar panels 4, of the hydraulic type; ·the control of a water circuit, particularly of collected rainwater, to cool the charging stations, or the batteries, or the inverter 37.

The universal control device 300 is configured to be connected to at least one sensor, for example a temperature sensor.

The sensor is, for example, configured to measure the temperature of a battery or a solar panel 4 or heated water.

The universal control device 300 is configured to be connected to a plurality of sensors.

The invention is particularly advantageous because, with a universal control device 300 equipped with different communication ports 305 usable according to different protocols, it is possible to meet diverse needs. The invention thus permits great modularity insofar as the same universal control device 300 can be used in different applications by implementing communication protocols that may differ from one application to another.

The universal control device 300 thus acts as a universal platform that is more advantageous than a conventional computer that cannot handle a multitude of protocols, unless additional boards are connected to it.

The present invention offers a much more compact, simple, secure, and practical solution than a conventional laptop computer.

The universal control device 300 is configured to operate with several (potentially all) of the following protocols:
CAN protocol (for “Controller Area Network”);
Modbus protocol;
I2C protocol (for “Inter-Integrated Circuit”);
electronic relay control protocol, for example to control an electric motor;
Mosfet transistor control protocol;
PWM (for “Pulse Width Modulation”) signal control protocol, specifically to control the electrical power transmitted to an electronic device;
Wi-Fi;
4G/5G network.

As illustrated in FIG. 15, the universal control device 300 is configured to be connectable to at least one of the following external devices 320:
an electrical inverter, for example associated with a battery;
a battery, notably to manage electricity storage in a battery;
an electrical charging device, notably for an electric vehicle, notably to manage the electrical charging of an electric car;
one or more cameras, notably one or more thermal cameras;
an electric motor, notably belonging to a water pump;
an electric fan;
one or more sensors, notably one or more temperature sensors;
one or more ultrasonic sensors;
one or more self-regulating cables (these are special heating cables designed to maintain a constant temperature in various applications);
one or more fire detection cables;
a lighting device;
a display device, for example an LCD or TFT type screen;
a keyboard;
a Wi-Fi module;
a 4G or 5G module.

The housing 301 can be made primarily of plastic material, in particular molded plastic material.

The housing 301 is closed, notably in a watertight manner, and has a shape inscribed in a geometric block.

The connection ports 305 are arranged in several rows 309.

In each row 309, the connection ports, for example numbering 4, 5, or 6, are aligned.

In the example described, the universal control device 300 comprises four rows 309 of connection ports 305 along four sides of one face of the housing 301.

The face of the housing 301 comprises a low wall 311, here of square or rectangular perimeter, and the rows 309 of connection ports are arranged around this low wall 311.

The connection ports 305 are on a single face 312 of the housing 301, here the lower face.

The rows 309 of connection ports are made on a bottom cover 314 of the housing 301.

The universal control device 300 is configured to be housed in a compartment 315 of the installation 1. The compartment 315 can comprise passages for connecting wires or cables going to the ports 305.

The universal control device 300 is configured to allow thermal management of the installation 1.

The connection ports 305 are chosen from: an HDMI connection port, and/or an Ethernet connection port, and/or a USB connection port.

The universal control device 300 is configured to operate with a 12-volt power supply.

The universal control device 300 is configured to operate at an electrical power of 100 watts, 200 watts, or 300 watts.

The universal control device 300 can be configured to provide heat, specifically via one or more cables, to prevent a conduit and/or a battery from freezing.

The invention thus relates to an assembly comprising the universal control device 300 and devices 320 of the installation 1 connected to the universal control device 300 to be controlled by this universal control device.

1. A universal control device comprising:
a housing; and
within the housing, an electronic control board configured to control external devices according to at least three, different communication protocols,
the electronic control board being connected to connection ports configured to allow the transmission, to external devices connected to these connection ports, of signals according to the different communication protocols.

2. The universal control device according to claim 1, wherein the electronic control board is a single board.

3. The universal control device according to claim 1, wherein the electronic components placed in the housing are components of a computer server, and the universal control device is configured as an artificial intelligence server.

4. The universal control device according to claim 1, wherein the universal control device further comprises at least one cooling system comprising an electric fan configured to cool electronic components inside the housing, wherein the electric fan is triggerable in connection with a temperature sensor configured to measure the temperature within the housing, the cooling system being placed within the housing.

5. The universal control device according to claim 1, wherein the universal control device is configured to perform edge computing data processing operations.

6. The universal control device according to claim 1, wherein the universal control device lacks an internal electrical power source, and the housing comprises an electrical power connector allowing an electrical power cable to be connected to the universal control device.

7. The universal control device according to claim 1, wherein the universal control device is configured to be connected to one or more energy management devices,

8. The universal control device according to claim 1, wherein the universal control device is configured to control several functions of an installation, these different functions being chosen from:
the transmission of data representative of a battery charge level;
the control of a fan to cool a solar panel;
the control of a hydraulic-type solar panel cleaning system; and
the control of a water circuit to cool a charging stations, or batteries, or an inverter.

9. The universal control device according to claim 1, wherein the universal control device is configured to be connected to at least one sensor, the at least one sensor comprising a temperature sensor configured to measure the temperature of a battery or of a solar panel or of heated water.

10. The universal control device according to claim 1, wherein the universal control device is configured to operate with at least one of the following protocols:
controller area network (CAN) protocol;
modbus protocol;
inter-integrated circuit (I2C) protocol;
electronic relay control protocol for controlling an electric motor;
mosfet transistor control protocol;
pulse width modulation (PWM) signal control protocol to control the electrical power transmitted to an electronic device;
Wi-Fi; and
4G/5G network.

11. The universal control device according to claim 1, wherein the universal control device is configured to be connectable to at least one of the following external devices:
an electrical inverter associated with a battery;
a battery to manage electrical storage in a battery;
an electrical charging device, to manage the electrical charging of an electric car;
one or more thermal cameras,
n electric motor, belonging to a water pump;
n electric fan;
one or more temperature sensors;
one or more ultrasonic sensors;
one or more self-regulating cables configured to maintain a constant temperature;
one or more fire detection cables;
a lighting device;
a display device;
a keyboard;
a Wi-Fi module; and
a 4G or 5G module.

12. The universal control device according to claim 1, wherein the housing is made primarily of plastic material wherein the housing closed in a watertight manner.

13. The universal control device according to claim 1, wherein the connection ports are arranged in one or more rows along four sides of a face of the housing and the universal control device is configured to allow operation with a Linux system and/or to allow an Internet connection and/or to allow a Wi-Fi connection and/or to allow a 4G/5G network connection and/or to allow coding in the Python language and/or to allow connection to artificial intelligence tools.

14. The universal control device according to claim 1, wherein the connection ports are selected from: an HDMI connection port, and/or an Ethernet connection port, and/or a USB connection port.

15. A power generation installation configured to be installed in on a ground, and comprising a central pillar configured to support at least one roof provided with at least one solar panel, the installation comprising a compartment for housing a universal control device according to claim 1, which is configured to control devices of the installation.
